(19) United States
(12) Patent Application Publication
(10) Pub. No.: US 2005/0187128 A1
(43) Pub. Date: Aug. 25, 2005

(54) Cosmetic composition of the compact powder type

(76) Inventors: Guenaelle Martin, Tokyo (JP); Agnes Themens, Bourg la Reine (FR); Maitena Collineau Leuridan, Paris (FR)

Correspondence Address: Thomas L. Irving;FINNEGAN, HENDERSON, FARABOW,, GARRETT & DUNNER, L.L.P., 901 New York Avenue, N.W., Washington, DC, 20001-4413, US

(21) Appl. No.: 11/043,284

(22) Filed: Jan. 27, 2005

Related U.S. Application Data
(60) Provisional application No. 60/541,367, filed on Feb. 4, 2004.

(30) Foreign Application Priority Data
Jan. 27, 2004 (FR) 04 50150

(51) Int. Cl. C11D 3/00

(52) U.S. Cl. 510/392

(57) ABSTRACT

The present disclosure relates to a cosmetic composition in the form of a compact powder for making up and/or caring for the skin, comprising at least one compound for absorbing sebum and/or adsorbing sebum and at least one fatty phase, wherein the fatty phase comprises a solid fatty phase in an amount of more than 40% by weight of its total weight. A method for giving the skin an appearance of homogeneous color and/or matteness comprising applying the compositions of the present disclosure is also disclosed.

This non provisional application claims the benefit of French Application No. 04 50150 filed on Jan. 27, 2004 and U.S. Provisional Application No. 60/541,637 filed on Feb. 4, 2004, both of which are hereby incorporated by reference.

The present disclosure relates to a cosmetic composition for making up and/or caring for the skin, such as the face, provided in the form of a compact powder. For example, the present disclosure relates to compositions that may constitute a make-up product, for example for the face, such as those having nontherapeutic care and/or treatment properties and intended, for instance, to reduce the shininess of so-called greasy skins and/or to improve the long-term staying power of the make-up, that is to say to prevent visual degradation during the day. This type of composition can also be termed a mattifying cosmetic composition.

In the field of powdery cosmetic compositions in the form of compact powders, there are generally used, on the one hand, a particulate phase comprising, for instance, pigments and/or fillers, and, on the other hand, a fatty phase comprising fatty substances, such as binder. This binder can be, for example, intended to provide a degree of cohesion to the particulate phase of the powders, so as to reduce the risks of fragmentation thereof under impact and to ensure easy collection thereof.

By way of illustration of the binders used in compact powders, there may be mentioned, for example, those described in the following documents. International Application No. WO 93/17660 describes cosmetic compositions in the form of a powder comprising, as binder, a siliconized fatty binder comprising at least one silicone oil, at least one silicone wax, at least one silicone resin, and optionally at least one silicone gum and at least one phenyldimethicone. European Patent No. EP 0 717 979 describes a method for preparing a composition comprising a fatty phase, which is predominantly liquid or essentially liquid, such as based on parleam oil, and a pulverulent phase, according to which the pulverulent phase is dispersed in an oil-in-water emulsion, the dispersion thus obtained is poured into a mould and then freeze-dried. European Patent No. EP 0 792 633 relates to the use of liquid esters having a wettability ranging from 30 seconds to 10 minutes, such as for example glyceryl triisostearate, as binders in compositions in the form of powders, in particular compacted powders. European Patent No. EP 0 923 927 describes pulverulent compositions for topical application, comprising at least one pulverulent compound whose particles are bound to each other by a binder comprising a liquid fatty phase and at least 2% by weight of a polymer that is dispersible in the liquid fatty phase.

In general, the binders used have been provided in liquid form. Now, this formulation may prove, in the case of powdery cosmetic compositions termed “mattifying,” damaging to the mattifying effect appearance, when used in a prolonged manner over time.

As specified above, a mattifying product is a product which can prevent the skin from shining and which can even out the complexion. To do this, it generally comprises at least one pulverulent compound of natural or synthetic origin capable, for instance, of absorbing sebum. These compounds are also called “sebum pumps.”

In fact, the liquid binder may be absorbed, at least in part, by the compounds of the sebum pump type, which may thereby affect their capacity to absorb and/or adsorb the sebum for which they are to be primarily dedicated.

This “parasitic” absorption can be, on the one hand, damaging for the obtaining of a prolonged mattifying effect over time and, on the other hand, can induce color inhomogeneity in the make-up composition.

The need therefore exists for a cosmetic composition in the form of a compact powder which can simultaneously have satisfactory cohesion and disintegration properties and which can make it possible to obtain a make-up having good mattifying capacity and good matt staying power over time.

The inventors have discovered, surprisingly, that it is possible to overcome at least one of the abovementioned disadvantages without, as a result, damaging the cohesion and disintegration properties of the compact powders, depending on the choice of a specific binding system.

Accordingly, the present disclosure relates, according to one of its aspects, to a cosmetic composition in the form of a compact powder, used for example, for making up and/or caring for the skin, such as the face, comprising at least one compound for absorbing sebum and/or adsorbing sebum and at least one fatty phase, wherein the fatty phase comprises a solid fatty phase in an amount of more than 40% by weight of its total weight.

According to one variant of the present disclosure, the composition as disclosed herein cannot comprise 10% by weight of Carnauba wax, 6% by weight of magnesium stearate and 5% by weight of amorphous aluminium and magnesium silicate, relative to the total weight of the composition.

Another aspect of the present disclosure is the use of at least one solid fatty phase and of at least one compound for absorbing sebum and/or adsorbing sebum in a cosmetic composition of the compact powder type in order to obtain a make-up which is homogeneous in color and/or in matteness.

Yet another aspect of the present disclosure is a method for making up and/or caring for the skin, comprising at least applying to the skin at least one composition as disclosed herein.

Still yet another aspect of the present disclosure is also the use of a composition as disclosed herein to obtain an appearance of the skin which is homogenous in color and/or in matteness.

As previously discussed, the compositions according to the present disclosure can be provided in the form of a compact powder. This compacted feature is obtained by subjecting the mixture of the particulate phase and the associated fatty binder to a compression.

For example, the compositions in the form of a compact powder as disclosed herein can be prepared by mixing the whole components of the particulate phase (fillers and pigments) and then by adding under agitation to this mixture the components comprising the fatty phase. The mixture is then ground, sieved, and then poured into a cup and compacted. This compacting can be accomplished, for example, using a press applying a pressure ranging from 50 to 250 bars to obtain the expected compact powder.

Consequently, the compositions according to the present disclosure can be different from the termed “poured particulate compositions,” which are prepared just by mixing a fatty phase in the molded state with a particulate phase.

As the compositions are provided in the form of a compact powder, they can have, comparatively with the poured type compositions, a better inclination to be disintegrated in the form of “free” solid particles. Thus, one can, after the unpacking of a compact composition as disclosed herein, recuperate its particulate phase, which is, for the most part, not possible with a poured composition. This unpacking can be realized, for example, according to the following process: the compacted product is broken using a spatula over a sieve (250μ) and then the obtained heaps of powder are sieved. Thus, the particulate phase of the compact powder is recovered in the form of “free” solid particles.

Compound Absorbing Sebum:

The compositions according to the present disclosure comprise at least one compound absorbing sebum, also called a “sebum pump.” As used herein, the expression “compound absorbing sebum” is understood to mean a compound capable of absorbing and/or adsorbing sebum. Generally, this type of compound is provided in the form of a powder with a sebum uptake.

For example, the sebum uptake of these compounds can be greater than or equal to 1 ml/g, such as from 1 ml/g to 20 ml/g, for instance from 1 ml/g to 15 ml/g. It may, for example, be greater than or equal to 1.5 ml/g, such as from 1.5 ml/g to 20 ml/g, and from 1.5 ml/g to 15 ml/g. According to another variant of the present disclosure, the sebum uptake of the compound may be greater than or equal to 2 ml/g, and may range, for example, from 2 ml/g to 20 ml/g, such as from 2 ml/g to 15 ml/g.

The sebum uptake corresponds to the quantity of sebum absorbed and/or adsorbed onto the available surface of the particles. It is measured according to the Wet Point method described below in the examples.

According to another aspect of the present disclosure, the particles of the at least one compound absorbing and/or adsorbing sebum may have a BET specific surface area greater than or equal to 300 m²/g, for instance greater than or equal to 500 m²/g, such as greater than or equal to 600 m²/g, and less than or equal to 1500 m²/g.

The particles of the at least one compound for absorbing and/or adsorbing sebum may be of inorganic or organic origin. They may be chosen, for example, from: silica, polyamide powders (nylon®), powders of acrylic polymers, such as polymethyl methacrylate, polymethyl methacrylate/ethylene glycol dimethacrylate, polyallyl methacrylate/ethylene glycol dimethacrylate, ethylene glycol dimethacrylate/lauryl methacrylate copolymer and powders of polyethylene, for instance, polyethylene/acrylic acid.

The particles of this compound may, where appropriate, be surface-treated with at least one hydrophobic treatment agent.

This hydrophobic treatment agent may be chosen, for example, from:
silicones, such as methicones, dimethicones;
fatty acids, such as stearic acid;
metallic soaps, such as aluminium dimyristate, aluminium salt of hydrogenated tallow glutamate;
perfluoroalkyl phosphates, perfluoroalkyl silanes, perfluoroalkyl silazanes, hexafluoropropylene polyoxides, polyorganosiloxanes comprising perfluoroalkyl perfluoropolyether groups;
amino acids, N-acylated amino acids and their salts;
lecithin, isopropyl triisostearyl titanate; and
mixtures thereof.

As used herein, the term “alkyl” mentioned in the compounds cited above is understood to mean a linear, branched or cyclic alkyl groups comprising from 1 to 30, atoms, for example, from 5 to 16 carbon atoms.

The N-acylated amino acids may comprise an acyl group comprising from 8 to 22 carbon atoms, such as for example a 2-ethylhaxanoyl, caproyl, lauroyl, myristoyl, palmitoyl, stearoyl and cocoyl group. The salts of these components may be the aluminium, magnesium, calcium, zirconium, zinc, sodium or potassium salts. The amino acid may be, for example, lysine, glutamic acid or alanine.

As non-limiting examples of the compounds for absorbing and/or adsorbing sebum according to the present disclosure, mention may be made of:
silica powders, such as for example the porous silica microspheres sold under the name “SILICA BEADS SB-700” marketed by the company MYOSHI, “SUNSPHERE® H51,” “SUNSPHERE® H33,” “SUNSPHERE® H53” marketed by the company ASAHI Glass; and the amorphous silica microspheres coated with polydimethylsiloxane which are sold under the name “SA SUNSPHERE® H-33” and “SA SUNSPHERE® H-53” by the company ASAHI GLASS,
powders of polyamides (nylon®), such as for example “ORGASOL® 4000” or “ORGASOL® 2002 EXTRA D NAT COS” marketed by the company ATOCHEM,
powders of acrylic polymers, for instance polymethyl methacrylate, such as for example “COVABEAD® LH85” marketed by the company WACKHERR; of polymethyl methacrylate/ethylene glycol dimethacrylate, such as for example “DOW CORNING 5640 MICROSPONGE® SKIN OIL ADSORBER” marketed by the company DOW CORNING, or “GANZPEARL® GMP-0820” marketed by the company GANZ CHEMICAL; of polyalyll methacrylate/ethylene glycol dimethacrylate, such as for example “POLY-PORE® L200” or “POLY-PORE® E200” marketed by the company AMCOL; of ethylene glycol dimethacrylate/lauryl methacrylate copolymer, such as for example “POLYTRAP® 6603” marketed by the company DOW CORNING, and
powders of polyethylene, for instance polyethylene/acrylic acid, which are sold under the trade name Flobeads® by the company SUMITOMO.

According to another variant of the present disclosure, the at least one compound for absorbing and/or adsorbing sebum is of mineral origin.

According to yet another variant of the present disclosure, the particles of the at least one compound for absorbing and/or adsorbing sebum is chosen from silica particles, polyethylene particles, polyamide powders and mixtures thereof. For example, the particles of the at least one compound absorbing and/or adsorbing sebum are silica particles. This silica may have, for instance, the characteristics described above, and may, for example, possess a sebum uptake of greater than or equal to 2 ml/g, such as ranging from 2 ml/g to 20 ml/g. Such silica particles are sold, for instance, under the names “SUNSPHERE® H 33” and “SUNSPHERE® H53” by the company ASAHI GLASS.

The compositions as disclosed herein can comprise the at least one compound for absorbing and/or adsorbing sebum in an amount ranging from 2% to 18% by weight, such as from 4% to 18% by weight, for instance from 5% to 15% by weight, relative to the total weight of the composition.

Fatty Phase:

As specified above, the at least one fatty phase is also commonly called a “binder” and serves, for example, as dispersing medium for the particulate phase. The at least one fatty phase can be present in the composition as disclosed herein in an amount ranging from 12% to 35% by weight, such as from 15% to 30% by weight, relative the total weight of the composition.

Solid Fatty Phase:

The composition according to the present disclosure comprises at least one fatty phase comprising, in an amount of more than 40% by weight of its weight, a solid fatty phase also called “solid binder”.

As used herein, the expression “solid binder” is understood to mean, a fatty phase whose melting point may be greater than or equal to 30° C., such as from 30° C. to 250° C., and from 30° C. to 230° C.

The at least one solid fatty phase may comprise at least one compound chosen from waxes, metallic soaps and mixtures thereof.

As disclosed herein, the expression “wax,” is understood to mean a lipophilic fatty compound which is solid at room temperature (25° C.) and atmospheric pressure (760 mmHg, that is 10⁵ Pa), which has a reversible solid/liquid change of state, and which has, for example, a melting point greater than or equal to 30° C., such as greater than or equal to 55° C., and for example, range up to 250° C., for instance, up to 230° C., and up to 120° C.

By heating the wax to its melting point, it is possible to make it miscible with oils and to form a microscopically homogeneous mixture; but upon bringing the temperature of the mixture back to room temperature, recrystallization of the wax from the oils of the mixture is obtained.

The melting point values correspond, as disclosed herein, to the peak of melting measured with the aid of a differential scanning calorimeter (DSC), for example the calorimeter sold under the name DSC 30 by the company METLER, with a temperature rise of 5° C. or 10° C. per minute.

The waxes, for the purposes of the present disclosure, may be those generally used in the cosmetics or dermatological fields. They can be, for example, hydrocarbon-based, silicone-based and/or fluorinated waxes, optionally comprising ester or hydroxyl functional groups. They can also be of natural or synthetic origin.

By way of non-limiting illustration of these waxes, mention may be made of, for example:
beeswax, lanolin wax, Chinese waxes; rice wax, Carnauba wax, Candelilla wax, Ouricury wax, cork fiber wax, sugar cane wax, Japan wax and sumac wax; Montana wax, microcrystalline waxes, paraffin waxes, ozokerites, ceresin wax, lignite wax, polyethylene waxes, the waxes obtained by Fisher-Tropsch synthesis, fatty acid esters and glycerides that are solid at 40° C., such as more than 55° C.,
the waxes obtained by catalytic hydrogenation of animal or vegetable oils having linear or branched C₈-C₃₂ fatty chains, such as hydrogenated jojoba oil, hydrogenated sunflower oil, hydrogenated castor oil, hydrogenated copra oil and hydrogenated lanolin oil,
silicone waxes or fluorinated waxes, and
mixtures thereof.

According to one aspect of the present disclosure, the solid fatty phase comprises at least one compound chosen from carnauba wax, paraffin wax and mixtures thereof.

According to another aspect of the present disclosure, the solid fatty phase may comprise at least one wax that exists completely or partially in the form of a powder, such as a micronized powder, in order to facilitate its use in the preparation of the cosmetic composition.

Among the waxes that can be used in powdered form, non-limiting mention can also be made, for example, of the microbeads of Carnauba wax sold under the name MICROCARE 350® by the company Micro Powders and the microbeads of paraffin wax that are sold under the name MICROEASE 114S® by the company Micro Powders.

The solid binder may also be chosen from metallic soaps.

Among these metallic soaps, non-limiting mention may be made of, for instance, the metallic soaps of fatty acids comprising from 12 to 22 carbon atoms, such as those comprising from 12 to 18 carbon atoms. The metal of the metallic soap may be, for example, zinc or magnesium.

The fatty acid may be chosen from, for example, lauric acid, myristic acid, stearic acid, palmitic acid and mixtures thereof.

As a metallic soap, it is possible to use zinc laurate, magnesium stearate, magnesium myristate, zinc stearate and mixtures thereof.

According to still another aspect of the present disclosure, the solid fatty phase may comprise at least one metallic soap that is present completely or partially in powdered form.

The at least one solid fatty phase may be present in an amount greater than or equal to 45% by weight, such as greater than or equal to 50% by weight, for instance, greater than or equal to 55% by weight, greater than or equal to 60% by weight, greater than or equal to 70%, and greater than or equal to 80% by weight relative to the total weight of the fatty phase.

According to one embodiment of the present disclosure, the at least one solid fatty phase may comprise the entire fatty phase.

According to one aspect of the present disclosure, the at least one solid fatty phase/at least one compound for absorbing sebum and/or adsorbing sebum weight ratio is at least equal to 1, and may range, for instance, from 1 to 2.5, such as from 1 to 2.3.

The composition as disclosed herein may thus comprise at least one solid fatty phase in an amount ranging from 8% to 25% by weight, for example from 10% to 22% by weight, such as from 11% to 20% by weight, relative to the total weight of the composition.

For example, non-limiting mention may be made of the following at least one compound for absorbing sebum and/or adsorbing sebum/solid fatty phase combinations suitable for the present disclosure:
porous silica microspheres such as, for example Sunsphere H-33®/micronized Carnauba or paraffin wax,
porous silica microspheres such as for example Sunsphere H-33®, and acrylic acid/polyethylene powder, such as for example Flobeads® ZA-209®/micronized Carnauba or paraffin wax and magnesium stearate or zinc stearate,
porous silica microspheres such as for example Sunsphere H-33®, acrylic acid/polyethylene powder, such as for example Flobeads ZA-209®, and polyamide powder such as for example Orgasol®/micronized Carnauba or paraffin wax and magnesium stearate or zinc stearate.
   Liquid Fatty Phase:

The at least one fatty phase of the composition according to the present disclosure may additionally comprise a liquid fatty phase comprising at least one oil. This oil may be chosen from the oils conventionally used as binder in compact powders.

The at least one oil may be chosen from, by way of non-limiting example:
mink oil, turtle oil, soya bean oil, grapeseed oil, sesame oil, maize oil, rapeseed oil, sunflower oil, cottonseed oil, avocado oil, olive oil, castor oil, jojoba oil, groundnut oil;
hydrocarbon oils such as paraffin oils, squalane, petroleum jelly, polydecene, for instance hydrogenated polydecene, such as “CERAFLOW E®” marketed by the company Shamrock;
fatty esters such as isopropyl myristate, isopropyl palmitate, butyl stearate, isodecyl stearate, hexyl laurate, isononyl isononanoate, 2-ethylhexyl palmitate, 2-hexyldecycl laurate, 2-octyldecyl palmitate, 2-octyldodecyl myristate or lactate, 2-diethylhexyl succinate, diisostearyl malate and glycerine or diglycerine triisostearate;
silicone oils such as polymethylsiloxanes, polymethylphenylsiloxanes, polysiloxanes modified with fatty acids, fatty alcohols or polyoxyalkylenes, fluorinated silicones and perfluorinated oils;
higher fatty acids such as myristic acid, palmitic acid, stearic acid, behenic acid, oleic acid, linoleic acid, linolenic acid and isostearic acid;
higher fatty alcohols such as cetanol or oleyl alcohol;
polymethylfluoroalkyl dimethylsiloxanes of formula (1): 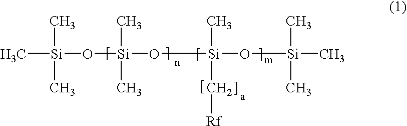
   wherein:
n is an integer ranging from 5 to 90, for instance from 30 to 80, such as from 50 to 80,
m is an integer ranging from 1 to 150, for instance from 1 to 80, such as from 1 to 40,
a is an integer ranging from 0 to 5, and
Rf is chosen from perfluoroalkyl radicals comprising from 1 to 8 carbon atoms; and
mixtures thereof.

Among the compounds of formula (1) that are suitable for the present disclosure, non-limiting mention may be made of those sold under the name X22-819®, X22-820®, X22-821®, X22-822® by the company SHIN-ETSU.

For example, the composition as disclosed herein can comprise a liquid fatty phase in an amount ranging from 4% to 15% by weight, such as from 6% to 13% by weight, for instance, from 7% to 13% by weight, relative to the total weight of the composition.

According to one aspect of the present disclosure, the weight ratio of the liquid fatty phase at least one compound for absorbing and/or adsorbing sebum may be less than or equal to 2, such as ranging from 0.5 to 2.

According to another aspect of the present disclosure, the composition as disclosed herein may be free of liquid fatty phase.

Of course, persons skilled in the art will be careful to adjust the quantities of solid fatty phase and optional liquid fatty phase of the composition according to the present disclosure such that their expected properties in terms of cohesion and mattifying effect over time are satisfactory.

Fillers:

The composition according to the present disclosure can further comprise at least one additional filler, that is to say distinct from the at least one compound for absorbing and/or adsorbing sebum already used in the composition.

The fillers may be inorganic or organic. The fillers may be particles of any form, for instance platelet, spherical or oblong form, regardless of their crystallographic form (for example sheet, cubic, hexagonal or orthothrombic form, and the like). Among the additional fillers that can be used in the compositions as disclosed herein, non-limiting mention may be made of, for example, talc, mica, silica, kaolin, powders of polyamide (Nylon®), poly-β-alanine and polyethylene, powders of polymers of tetrafluoroethylene (Teflon®), lauryllysine, starch, boron nitride, powders of acrylic acid polymers, microbe's of silicone resin (Tospearls® from Toshiba for example), precipitated calcium carbonate, magnesium carbonate and hydrocarbonate, hydroxyapatite, hollow silica microspheres, and ceramic microcapsules.

The composition according to the present disclosure may comprise at least one additional filler, or a mixture of additional fillers, in an amount ranging from 40% to 95% by weight, for instance from 45% to 85% by weight, such as from 45% to 70% by weight, relative to the total weight of the composition.

Pulverulent Colouring Material

The particulate phase of the composition as disclosed herein may additionally comprise, for example, at least one pulverulent coloring material, which may be chosen from pigments and pearlescent agents normally used in cosmetic and/or dermatological compositions.

The pigments may be white or colored, inorganic and/or organic, coated or noncoated. There may be mentioned, by way of non-limiting example among the inorganic pigments, titanium dioxide which is optionally surface-treated, zirconium or cerium oxides and iron or chromium oxides, manganese violet, ultramarine blue, chromium hydrate and ferric blue. Among the organic pigments, non-limiting mention may be made, for example, of carbon black, pigments of the D & C type, and lacquers based on carmine, barium, strontium, calcium or aluminium.

The pearlescent agents may be chosen from white pearlescent pigments such as mica coated with titanium, or with bismuth oxychloride, colored pearlescent pigments such as mica-titanium with iron oxides, mica-titanium with, for instance, ferric blue or chromium oxide, mica-titanium with an organic pigment of the aforementioned type and pearlescent pigments based on bismuth oxychloride.

The pulverulent coloring material can be present in the composition in an amount ranging from 0.5% to 30% by weight, such as from 1% to 22% by weight, for instance, from 3% to 18% by weight relative to the total weight of the composition.

Additives:

The composition may also comprise at least one adjuvant normally used in cosmetics, such as water-soluble or fat-soluble colouring agents, preservatives, cosmetic active agents, moisturizing agents, UV-screening agents, thickeners, water, surfactants and/or perfumes.

Of course, persons skilled in the art will be careful to choose the possible adjuvant(s) added to the composition according to the present disclosure such that the advantageous properties intrinsically attached to the composition as disclosed herein are not, or not substantially, impaired by the addition envisaged.

The composition according to the present disclosure may be provided, for example, in the form of a make-up product of the compact powder type, such as in the form of a blusher, an eyeshadow, a face powder, a foundation, a concealer product, a make-up product for the body, or else in the form of a care product for the face or a care product for the body.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific example are reported as precisely as possible. Any numerical value, however, inherently contain certain errors necessarily resulting from the standard deviation found in their respective testing measurements.

The following examples are intended to illustrate the invention in a non-limiting manner.

### EXAMPLES

The following formulations were prepared according to the methods of preparation conventionally used in the cosmetic field.

Method of Measuring the Sebum Uptake of a Powder

The sebum uptake of a powder was measured according to the method for determining the oil uptake of a powder described in the NF T 30-022 standard. It corresponds to the quantity of sebum adsorbed onto the available surface of the powder and/or absorbed by the powder by measurement of the Wet Point, described below:

A quantity m (in grams) of powder ranging from 0.5 g to 5.0 g (the quantity depends on the density of the powder) was placed on a glass plate and then there was added, dropwise, artificial sebum maintained at the temperature of 29° C. and having the following composition:

| | |
|---|---|
| triolein | 29.00% |
| oleic acid | 28.50% |
| oleyl oleate | 18.50% |
| squalene | 14.00% |
| cholesterol | 7.00% |
| cholesterol palmitate | 3.00% |

After adding 4 to 5 drops of artificial sebum, the artificial sebum was incorporated into the powder with the aid of a spatula and the addition of artificial sebum was continued until the formation of conglomerates of artificial sebum and of powder was obtained. From this moment, the artificial sebum was added in an amount of one drop at a time and the mixture was then triturated with the spatula. The addition of artificial sebum was stopped when a firm and smooth paste was obtained. This paste should be spreadable on the glass plate without cracks or formation of lumps. The volume Vs (expressed in ml) of artificial sebum used was then noted.

The sebum uptake corresponds to the Vs/m ratio.

### Example 1

### Compact Foundation

| Constituent | Amount |
|---|---|
| yellow, brown, black iron oxides | 5.75 g |
| talc | 56.25 g |
| microspheres of amorphous silica: Sunsphere | 10.00 g |
| H-33 from Asahi Glass | |
| microbeads of Carnauba wax: Microcare | 20.00 g |
| 350 ® from Micro Powders | |
| hydrogenated polydecene: Ceraflow E ® from | 3.00 g |
| Shamrock | |
| polymethyltrifluoropropyl dimethylsiloxane: | |
| X22-819 ® from Shinetsu | 5.00 g |

The composition was prepared by mixing all of the powders (iron oxides, silica, Carnauba wax) and then by adding thereto the oils (hydrogenated polydecene, fluorinated silicone), this material was then ground and sieved until a homogeneous mixture was obtained. Part of the composition was placed in a cup and then compacted.

A compact powder was obtained whose application to the face produces a make-up having good matteness during the day.

### Example 2

### Foundation

| Constituent | Amount |
|---|---|
| yellow, brown, black iron oxides | 3.23 g |
| microspheres of amorphous silica: | 1.00 g |
| Sunsphere ® H-33 from Asahi-glass | |
| preservatives | qs |
| titanium dioxide | 10.55 g |
| sericite | 15.00 g |
| boron nitride | 6.00 g |
| talc | 28.30 g |
| polyurethane and silica powder (98/2): | 3.00 g |
| Plastic Powder ® D-400 from Toshiki | |
| titanium dioxide - zinc oxide - coated talc | 4.00 g |
| methylhydrogenopolysiloxane: | |
| TZ Powder ® type 2 from Miyoshi | |
| powder of crosslinked polydimethylsiloxane: | 2.00 g |
| Trefil Powder ® E-506 C from Dow Corning | |
| powder of ethylene/acrylic acid copolymer: | 5.00 g |
| Flobeads ® EA-209 from Sumitomo | |
| microbeads of paraffin wax: | 10.00 g |
| Microease ® 114S from Micro Powders | |
| magnesium stearate | 3.00 g |
| polymethyltrifluoropropyl dimethylsiloxane: | 2.92 g |
| X22-819 ® from Shin Etsu | |
| 2-ethylhexyl 4-p-methoxycinnamate | 4.00 g |
| isononyl isononanoate | 1.20 g |

### Example 3

### Foundation

| Constituent | Amount |
|---|---|
| yellow, brown, black iron oxides | 3.23 g |
| titanium dioxide coated with lauroyl lysine (95/5) | 9.00 g |
| titanium dioxide - zinc oxide - coated talc | 4.00 g |
| methylhydrogenopolysiloxane: | |
| TZ Powder ® type 2 from Miyoshi | |
| preservatives | qs |
| talc | 30.80 g |
| microspheres of amorphous silica: | 1.00 g |
| Sunsphere ® H-33 from Asahi-glass | |
| microbeads of silica: | 1.00 g |
| SILICA BEADS ® SB150 from Miyoshi | |
| polyurethane and silica powder (98/2): | 5.00 g |
| Plastic Powder ® D-400 from Toshiki | |
| powder of ethylene/acrylic acid copolymer: | 5.00 g |
| Flobeads ® EA-209 from Sumitomo | |
| nylon powder: | 5.00 g |
| ORGASOL ® 2002 EXTRA D NAT COS | |
| powder of crosslinked polydimethylsiloxane: | 2.00 g |
| Trefil Powder ® E-506 C from Dow Corning | |
| microbeads of paraffin wax: | 8.00 g |
| Microease ® 114S from Micro Powders | |
| sericite coated with Carnauba wax (94.5/5.5): | 15.00 g |
| Sericite UW-A5 ® from Toshiki | |
| magnesium stearate | 3.00 g |
| isononyl isononanoate | 1.20 g |
| polymethyltrifluoropropyl dimethylsiloxane: | 2.00 g |
| X22-819 ® from Shin Etsu | |
| 2-ethylhexyl 4-p-methoxycinnamate | 4.00 g |

Although the present disclosure herein has been described with reference to particular embodiments, it is to be understood that these embodiments are merely illustrative of the principles and applications of the present disclosure. It is therefore to be understood that numerous modifications may be made to the illustrative embodiments and that other arrangements may be devised without departing from the spirit and scope of the present disclosure as defined by the claims.

1. A cosmetic composition comprising at least one compound for absorbing sebum and/or adsorbing sebum and at least one fatty phase, wherein the fatty phase comprises a solid fatty phase in an amount of more than 40% by weight, relative to the weight of the fatty phase,
wherein the composition is in the form of a compact powder, and
with the proviso that the solid fatty phase does not comprise 10% by weight of Carnauba wax, 6% by weight of magnesium stearate, and 5% by weight of amorphous aluminium and magnesium silicate, relative to the total weight of the composition.

2. The cosmetic composition according to claim 1, wherein the solid fatty phase has a melting point greater than 30° C.

3. The cosmetic composition according to claim 1, wherein the solid fatty phase is present in an amount greater than or equal to 45% by weight, relative to the total weight of the fatty phase.

4. The cosmetic composition according to claim 1, wherein the solid fatty phase comprises at least one compound chosen from waxes and metallic soaps.

5. The cosmetic composition according to claim 1, wherein the solid fatty phase comprises at least one wax chosen from:
beeswax, lanolin wax, Chinese waxes; rice wax, Carnauba wax, Candelilla wax, Ouricury wax, cork fibre wax, sugar cane wax, Japan wax, sumac wax; Montana wax, microcrystalline waxes, paraffin waxes, ozokerites, ceresin wax, lignite wax, polyethylene waxes, the waxes obtained by Fisher-Tropsch synthesis, fatty acid esters, glycerides that are solid at 40° C.,
the waxes obtained by catalytic hydrogenation of animal or vegetable oils having linear or branched C₈-C₃₂ fatty chains,
silicone waxes and fluorinated waxes.

6. The cosmetic composition according to claim 5, wherein the solid fatty phase comprises at least one wax chosen from paraffin waxes and Carnauba waxes.

7. The cosmetic composition according to claim 5, wherien the solid fatty phase comprises at least one wax which is present in the composition at least partially in powdered form.

8. The cosmetic composition according to claim 1, wherein the solid fatty phase comprises at least one compound chosen from zinc laurate, magnesium stearate, magnesium myristate, and zinc stearate.

9. The cosmetic composition according to claim 1, wherein the weight ratio of the solid fatty phase to the at least one compound for absorbing sebum and/or adsorbing sebum is at least equal to 1.

10. The cosmetic composition according to claim 1, wherein the solid fatty phase is present in an amount ranging from 8% to 25% by weight, relative to the total weight of the composition.

11. The cosmetic composition according to claim 1, comprising at least one liquid fatty phase.

12. The cosmetic composition according to claim 11, wherein the at least one liquid fatty phase comprises at least one oil chosen from: mink oil, turtle oil, soya bean oil, grapeseed oil, sesame oil, maize oil, rapeseed oil, sunflower oil, cottonseed oil, avocado oil, olive oil, castor oil, jojoba oil, groundnut oil, hydrocarbon oils, fatty esters, silicone oils, higher fatty acids, higher fatty alcohols, and
polymethylfluoroalkyl dimethylsiloxanes of formula (1): 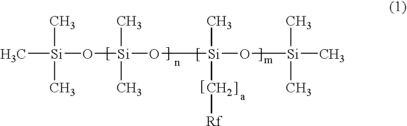
wherein:
n is an integer ranging from 5 to 90,
m is an integer ranging from 1 to 150,
a is an integer ranging from 0 to 5, and
Rf is chosen from perfluoroalkyl radicals comprising from 1 to 8 carbon atoms.

13. The cosmetic composition according to claim 11, wherein the weight ratio of the at least one liquid fatty phase to the at least one compound for absorbing sebum and/or adsorbing sebum is less than or equal to 2.

14. The cosmetic composition according to claim 11, wherein the at least one liquid fatty phase is present in an amount ranging from 4% to 15% by weight, relative to the total weight of the composition.

15. The cosmetic composition according to claim 1, wherein the at least one fatty phase is present in an amount ranging from 12% to 35% by weight, relative to the total weight of the composition.

16. The cosmetic composition according to claim 1, wherein the at least one compound for absorbing sebum and/or adsorbing sebum has a sebum uptake of greater than or equal to 1 ml/g.

17. The cosmetic composition according to claim 1, wherein the at least one compound for absorbing sebum and/or adsorbing sebum is in the form of particles having a BET specific surface area of greater than or equal to 300 m²/g.

18. The cosmetic composition according to claim 1, wherein the at least one compound for absorbing sebum and/or adsorbing sebum are chosen from particles of mineral and organic origin.

19. The cosmetic composition according to claim 18, wherein the at least one compound for absorbing sebum and/or adsorbing sebum are particles chosen from silica, polyamide powders, powders of acrylic polymers, and powders of polyethylene.

20. The cosmetic composition according to claim 1, wherein the at least one compound for absorbing sebum and/or adsorbing sebum are surface-treated particles with at least one hydrophobic treatment agent.

21. The cosmetic composition according to claim 1, wherein the at least one compound for absorbing sebum and/or adsorbing sebum is present in an amount ranging from 2% to 18% by weight, relative to the total weight of the composition.

22. The cosmetic composition according to claim 1, comprising a combination of at least one compound for absorbing sebum and/or adsorbing sebum and at least one solid fatty phase, chosen from:
porous silica microspheres/Carnauba or micronized paraffin wax,
porous silica microspheres and acrylic acid/polyethylene powder/Carnauba or micronized paraffin wax and magnesium stearate or zinc stearate, and
porous silica microspheres, polyethylene/acrylic acid powder and polyamide powder/Carnauba or micronized paraffin wax, and magnesium stearate or zinc stearate.

23. The cosmetic composition according to claim 1, further comprising at least one additional filler different from the at least one compound for absorbing sebum and/or adsorbing sebum.

24. The cosmetic composition according to claim 23, wherein the at least one additional filler is chosen from talc, mica, silica, kaolin, powders of polyamide, powders of poly-β-alanine, powders of polyethylene, powders of polymers of tetrafluoroethylene, lauryllysine, starch, boron nitride, powders of acrylic acid polymers, microbeads of silicone resin, precipitated calcium carbonate, magnesium carbonate, magnesium hydrocarbonate, hydroxyapatite, hollow silica microspheres, and ceramic microcapsules.

25. The cosmetic composition according to claim 23, wherein the at least one additional filler is present in an amount ranging from 40% to 95% by weight, relative to the total weight of the composition.

26. The cosmetic composition according to claim 1, further comprising at least one pulverulent coloring material.

27. The cosmetic composition according to claim 26, wherein the at least one pulverulent coloring material is chosen from pigments and pearlescent agents.

28. The cosmetic composition according to claim 26, wherein the at least one pulverulent coloring material is present in an amount ranging from 0.5% to 30% by weight, relative to the total weight of the composition.

29. The cosmetic composition according to claim 1, further comprising at least one adjuvant chosen from fat-soluble and water-soluble colouring agents, preservatives, cosmetic active agents, moisturizing agents, UV-screening agents, thickeners, water, surfactants and/or perfumes.

30. The cosmetic composition according to claim 1, wherein the cosmetic composition is present in a form chosen from a blusher, an eyeshadow, a face powder, a foundation, a concealer product, a make-up product for the body, a care product for the face or a care product for the body.

31. The cosmetic composition according to claim 30, wherein the cosmetic composition is in the form of a foundation.

32. A method for making up the skin, comprising
applying to the skin a compact powder cosmetic composition comprising at least one solid fatty phase and at least one compound for absorbing sebum and/or adsorbing sebum in an amount effective to provide a make-up that is homogeneous in color and/or in matteness.

33. The method according to claim 32, wherein weight ratio of the at least one solid fatty phase to the at least one compound for absorbing sebum and/or adsorbing sebum is at least equal to 1.

34. The method according to claim 32, wherein the at least one solid fatty phase comprises at least one compound chosen from waxes and metallic soaps.

35. The method according to claim 32, wherein the at least one compound for absorbing sebum and/or adsorbing sebum has a sebum uptake of greater than or equal to 1 ml/g.
